(19) United States
(12) Patent Application Publication
(10) Pub. No.: US 2018/0142723 A1
(43) Pub. Date: May 24, 2018

(54) FASTENER WITH CLEANING AND LEVELING WINGS

(71) Applicant: Phillips Screw Company, Burlington, MA (US)

(72) Inventor: Arnold R. Craven, JR., Agawam, MA (US)

(21) Appl. No.: 15/809,489

(22) Filed: Nov. 10, 2017

Related U.S. Application Data
(60) Provisional application No. 62/424,061, filed on Nov. 18, 2016.

(51) Int. Cl. F16B 43/00; F16B 25/10; B21H 3/02

(52) U.S. Cl. CPC F16B 43/001; B21H 3/027; F16B 25/10

(57) ABSTRACT

Fasteners, methods of forming fasteners, and methods of securing a work piece to a substrate using a fastener. Embodiments include fasteners having a structural feature below the head. The upper extent of the structural feature is on a plane parallel to the leading surface of a fastener head. Embodiments include a washer between the head and the structural feature. The structural feature may include a cutting edge for cutting and/or reaming a portion of the work piece.

### CROSS REFERENCE TO RELATED APPLICATION

This application claims priority under 35 U.S.C. § 119(e) to Provisional U.S. Patent Application Ser. No. 62/424,061, filed on Nov. 18, 2016, which is hereby incorporated by reference.

### BACKGROUND

Using a fastener to secure a work piece to a substrate has a number of advantages, including securing the work piece in a time efficient manner. However, penetrating the work piece also creates a hole through which intrusion, for example, water, may occur and is undesirable. This is particularly true for roofing and other external building structural materials, which must prevent water, and other environmental conditions, from intruding into a building or similar structure.

Sealing washers may be used between a head of a fastener and the work piece in order to minimize the impact of the fastener hole in the work piece. However, in many circumstances the known fastener and washer combinations are still not effective at preventing environmental intrusion. Thus, improvements in fastener design are desired.

### SUMMARY

Disclosed herein are example embodiments describing threaded fasteners, methods of forming threaded fasteners, and methods of securing a work piece to a substrate. In one aspect, disclosed herein, a threaded fastener for fastening a work piece to a substrate includes a head having a top surface and a leading surface and a shank having a threaded section and an unthreaded section. In another aspect, at least one wing extends from an unthreaded section in a radially outward direction from a longitudinal axis of a shank. In one aspect, at least one wing is included for cutting a work piece. In another aspect, at least one wing has an upper extent on a plane parallel to a leading surface of a head. And in yet another aspect, a fastener includes at least one washer disposed between at least one wing and a head. In yet another aspect, a washer has a thickness substantially equal to a distance between an upper extent of at least one wing and a leading surface of the head.

In one aspect of a fastener embodiment, at least one wing is configured to maintain a washer substantially parallel with a leading surface of a head during insertion. In another aspect, a distance between an upper extent of at least one wing and a leading surface of a head is greater than zero. In another aspect, a threaded fastener includes a distance between an upper extent of at least one wing and a leading surface of a head and is dimensioned such that at least one wing does not fully pass through the entirety of a thickness of a work piece when the threaded fastener is in a secured configuration. In yet another aspect, at least one wing increases in radius in a direction toward a head. In one aspect, at least one wing radiates outward from an unthreaded section of a shank. In one particular aspect, at least one wing has an outer radius greater than an outer radius of a thread. And in yet another aspect, at least one wing has an outer radius greater than a greatest outer radius of a threaded section.

In one aspect disclosed here, a washer includes an inner radius and the washer inner radius is greater than a greatest outer radius of a threaded section. In another aspect a washer includes an inner radius and the washer inner radius is less than an outer radius of at least one wing. In another aspect, a washer has a thickness which is greater than or equal to one half a distance between an upper extent of at least one wing and a leading surface of a head. And in yet another aspect a washer has a thickness that is equal to a distance between the upper extent of the at least one wing and the leading surface of a head.

A method of forming a threaded fastener for fastening a work piece to a substrate is disclosed herein. In one aspect, a method includes providing a shank having an unthreaded section and forming a head having a top surface and a leading surface. In another aspect, the method includes rolling a shank to form a threaded section comprising threads. In another aspect, the method includes pinching an unthreaded section to form at least one wing extending from the unthreaded section in a radially outward direction from a longitudinal axis of a shank. And in yet another aspect, the method includes forming at least one wing for cutting the work piece. And in yet another aspect, the method includes forming at least one wing having an upper extent on a plane parallel to a leading surface of a head. In one aspect, a method is disclosed including heat treating and/or plating a fastener. In another aspect, the method includes placing over a threaded section at least one washer between at least one wing and a head. In one aspect, the method include adding a washer to the fastener, the washer having a thickness substantially equal to a distance between an upper extent of at least one wing and a leading surface of a head. And in yet another aspect, a distance between an upper extent of at least one wing and a leading surface of a head is greater than zero.

In one example a method of securing a work piece to a substrate is disclosed herein. In one aspect, a method includes providing a threaded fastener having a head, the head having a top surface and a leading surface, and a shank having a threaded section and an unthreaded section. In another aspect, a method includes providing a threaded fastener having at least one wing that extends from an unthreaded section in a radially outward direction from a longitudinal axis of a shank. In one aspect, a method includes providing a threaded fastener having at least one wing included for cutting a work piece. In another aspect, a method includes providing a threaded fastener having at least one wing having an upper extent on a plane parallel to a leading surface of a head. And in yet another aspect, a method includes providing a threaded fastener having at least one washer disposed between wings and a head. In yet another aspect, a method includes providing a threaded fastener having a washer having a thickness substantially equal to a distance between an upper extent of at least one wing and a leading surface of the head. In one example method disclosed herein, a method includes screwing a fastener into a work piece. In yet another aspect disclosed herein, a method includes reaming at least a portion of a thread cut in a work piece by a threaded section. And in yet another aspect, a method includes seating a washer between a leading surface and a work piece for sealing a hole formed by a fastener in the work piece.

Additional features, advantages, and embodiments of the disclosure may be set forth or apparent from consideration of the following attached detailed description and drawings. It should be understood that features of a single embodiment, or aspect, may be combined with features of another embodiment, or with other aspects. Moreover, it is to be understood that both the foregoing summary of the disclosure and the following attached detailed description are exemplary and intended to provide further explanation without limiting the scope of the disclosure as claimed.

### BRIEF DESCRIPTION OF THE DRAWINGS

FIG. 1 is a side view of a fastener and a cross-sectional view of a washer in accordance with disclosed embodiments;

FIG. 2 is a side view of a fastener like FIG. 1 without a washer in accordance with disclosed embodiments;

FIG. 3 is a view of a fastener and washer like FIG. 1 taken in the direction of arrow III of FIG. 1;

FIGS. 4 through 7 are views like FIG. 1 illustrating insertion of the fastener into a work piece and substrate in accordance with disclosed methods and embodiments;

FIG. 8 is a side view of a fastener and a cross-sectional view of a sealant in accordance with disclosed embodiments;

FIG. 9 is a side view of a fastener like FIG. 8;

FIGS. 10 through 11 are views like FIG. 8 illustrating insertion of the fastener into a work piece and substrate in accordance with disclosed methods and embodiments;

FIG. 12 is a side view of a fastener in accordance with disclosed embodiments;

FIG. 13 is a cross-sectional view of the fastener of FIG. 12;

FIG. 14 is a side view of a fastener in accordance with disclosed embodiments;

FIG. 15 is a cross-sectional view of the fastener of FIG. 14;

FIG. 16 is a side view of a fastener in accordance with disclosed embodiments;

FIG. 17 is a cross-sectional view of the fastener of FIG. 16;

FIG. 18 is a side view of FIG. 16 is a view of a fastener and washer like FIG. 16 taken in the direction of arrow XVIII of FIG. 16;

FIGS. 19 through 20 are views like FIG. 12-15 illustrating insertion of the fastener into a work piece and substrate in accordance with disclosed methods and embodiments; and

FIG. 21 is a cross-sectional view of a fastener and a sealant in accordance with disclosed embodiments.

The present disclosure is further described in the detailed description that follows.

### DETAILED DESCRIPTION

It has been determined that prior fastener/washer combinations fail to adequately seal the hole formed by the fastener in the work piece due to a number of factors. For example, a rough area, which may be a rough edge or a rough surface may be formed at the top surface (the surface exposed to the environment) of the work piece by the penetration of the work piece by the fastener. This rough area may be a result of work piece deformities or natural inconsistencies. The rough area may prevent the sealing washer from fully contacting the work piece, which may result in the decreased effectiveness of the seal. Another potential source of a rough area at the work piece is the bulging of the work piece during fastener insertion. This may be particularly applicable to composite and plastic work piece materials. However, it may still occur in other materials. In addition to instances where a rough area can reduce sealing efficacy, material/debris removed from the work piece by the fastener threads may also get trapped under the sealing washer and prevent a suitable seal from forming between the washer and work piece. Improper installation may be another factor contributing to a failed seal. For example, if the installers of a prior art fastener fails to maintain a level washer during installation, the washer may be placed under compression at an angle with the work piece surface or otherwise improperly seat, which can result in reduced sealing effectiveness. Regardless of the applicable factors relevant to a particular work piece, the result with the prior fasteners is a seal that fails to provide sufficient contact between the fastener, washer, and work piece, which can result in intrusion of the environment through the work piece at the fastener threaded hole.

Embodiments disclosed herein describe fasteners having a structural feature, the upper extent of which, is on a plane substantially parallel to the leading surface of the head. Embodiments disclosed herein also disclose a cutting edge for cutting and/or reaming a portion of the work piece. Example embodiments disclosed herein also describe fasteners in which the cutting edge and upper extent are part of the same structural feature. Aspects of the disclosed example fasteners allow the fastener to bore into the surface of the work piece creating a clean rounded level and flat surface to enhance mating of the sealant with the work piece. Aspects of the disclosed example fasteners also provide a level surface/mount for a sealant/washer to rest evenly, which can aid in preventing the washer from falling towards, and interfering with, the threaded section as it engages the work piece. Further, aspects of the disclosed example fasteners hold and maintain the sealant/washer level with the head to ensure the engagement of sealant/washer is flush with the work piece. While still another advantageous aspect of example disclosed fasteners includes being dimensioned to hold the sealant/washer in place to prevent the washer from being askew during installation. Thus, disclosed embodiments provide a secure seating of the sealant/washer, which ensures a tight engagement and a flush mount between the fastener, washer, and the work piece. The tight engagement and flush mount provides an improved barrier at the finished work piece and may be used to stop water, or other liquids, dust, or gasses from entering the threaded hole. The tight seating also improves and/or eliminates liquids from filling the hole and/or pooling. Example applications include, for example, plastic, wood, concrete, metal, cement, corrugated aluminum, metal, or fiberglass roofing, composite and wood decking, plastic and metal frame windows, plumbing fixtures such as toilets, swimming pools, and exterior electrical boxes that require sealing. Further, disclosed embodiments also increase fastener and washer seating making them advantageous in uses exposed to vibrations, for example, turbine generators, industrial fans, air conditioning units, gondolas, chair lifts, lockers, heavy equipment, vehicles, automobiles, roof racks, aftermarket items, among others.

For the purpose of this disclosure the “up” or “upper” direction refers to a direction from a tip or point of the fastener towards the head. Thus, if the fastener was being inserted into a work piece, the fastener would be inserted in a downward direction toward the work piece, while the head would be in an upper direction. This convention is the same throughout this application, regardless of whether the work piece is parallel, perpendicular, or any other angle with respect to the Earth.

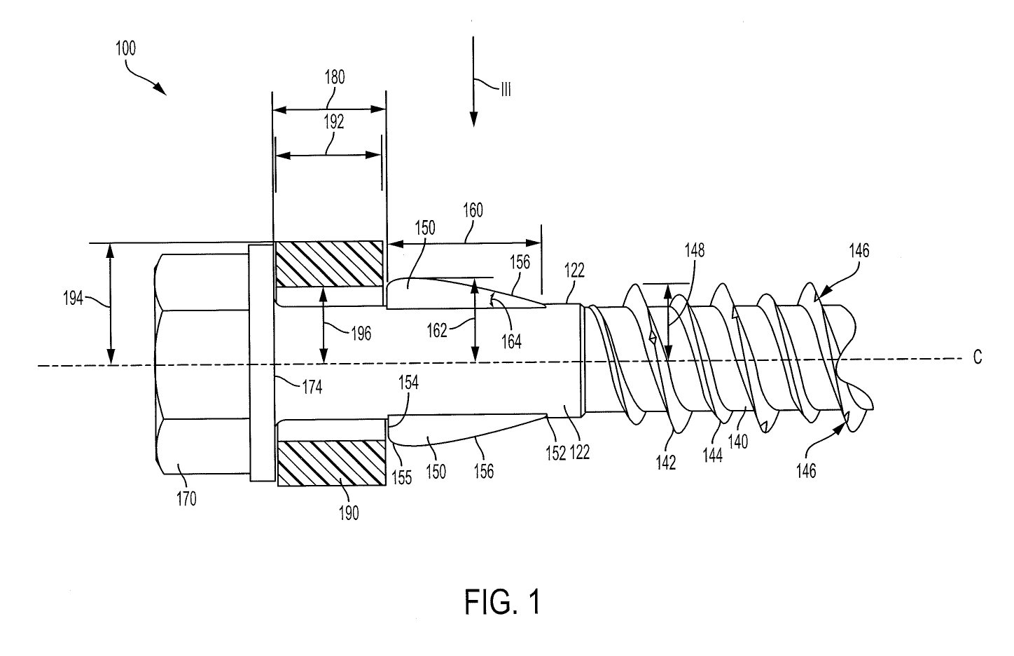

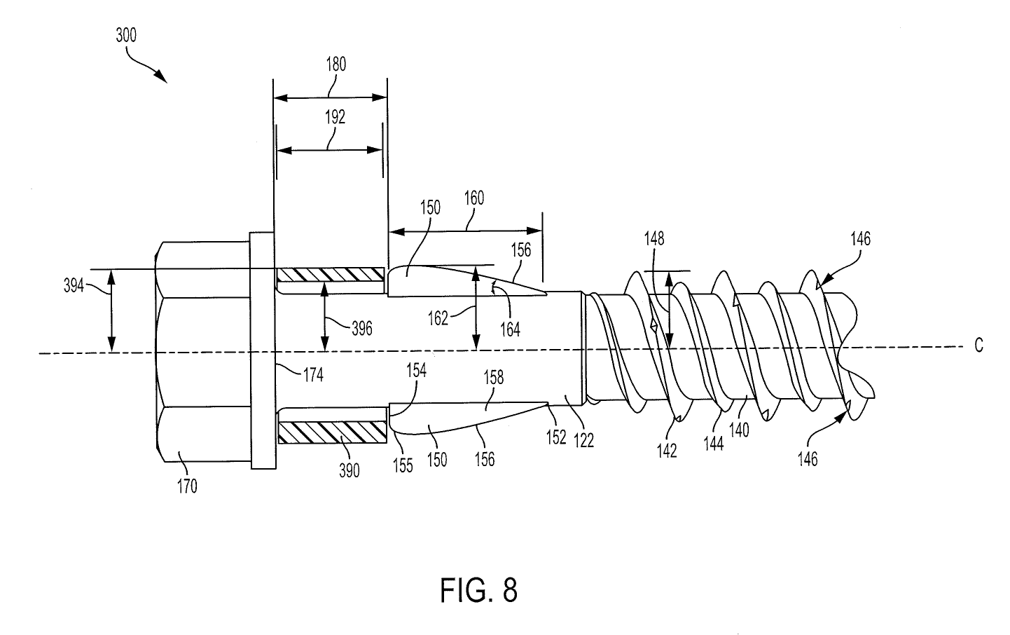

The differences between uses of “sealant” and “washer” for the purposes of this disclosure depends on the way in which the sealant/washer is sized to contact and form a seal with the work piece and the relative size of the sealant/washer to the respective wings. For the purposes of this disclosure, when referring to a “washer,” the sealant/washer will be sized to generally rest on a top surface of the work piece in a secured position of the fastener. When referring to a “sealant,” the sealant/washer will be sized to generally enter the bore hole formed by the wings in a secured position of the fastener. Other than this size, a “sealant” and a “washer” will be referred to interchangeable. Fastener 100, as described below with reference to FIG. 1, is shown with a washer. While fastener 100, as described below with reference to FIGS. 8-11, is shown with a sealant.

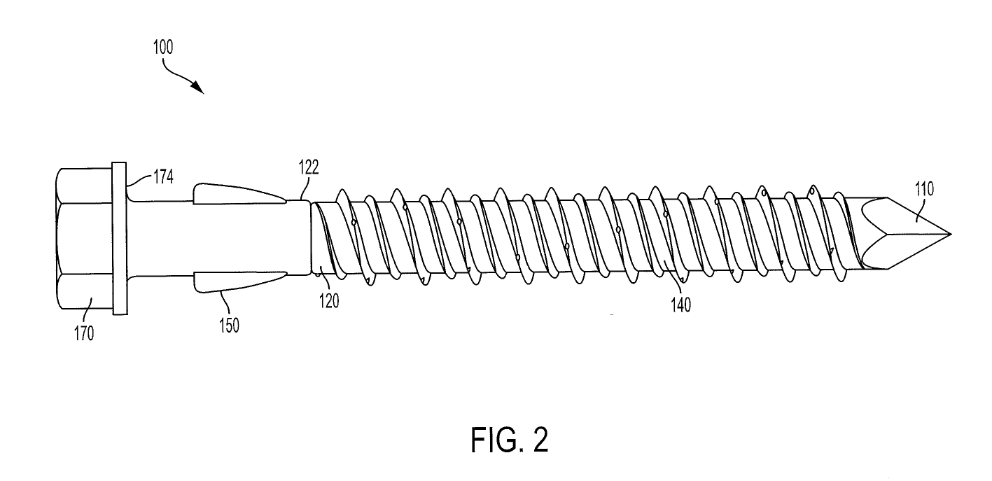

With reference to FIG. 1, one example threaded fastener 100 is shown. Fastener 100 includes a head 170 and a shank 120 having an unthreaded section 122 and a threaded section 140 between the head 170 and the point 110 (FIG. 2). The threaded section 140 may include threads appropriate for the associated work piece and/or substrate. As shown, threaded section 140 includes high 142-low 144 threads having two thread starts, which may be useful, for example, in concrete or masonry applications. As shown, the high thread may include notches 146, in one example, which may be useful to clean and remove masonry dust or other debris from the threads. However, other threads, or thread features, appropriate to the material may be used.

The head 170 may have any drivable configuration suitable to the installation environment. In one example, the head 170 is a hexagon washer head having a circular collar with a larger flat bearing surface or leading surface 174 to contact and/or compress a sealant or washer 190. However, any type of driver engageable head may be suitable. Head configurations having generally flat underside or leading surfaces may have certain advantages with respect to flat washer contact or compression in certain configurations. Other configurations, including example heads having locking features on the leading surface, or features minimizing rotation after installation, may also be used and may have other advantages.

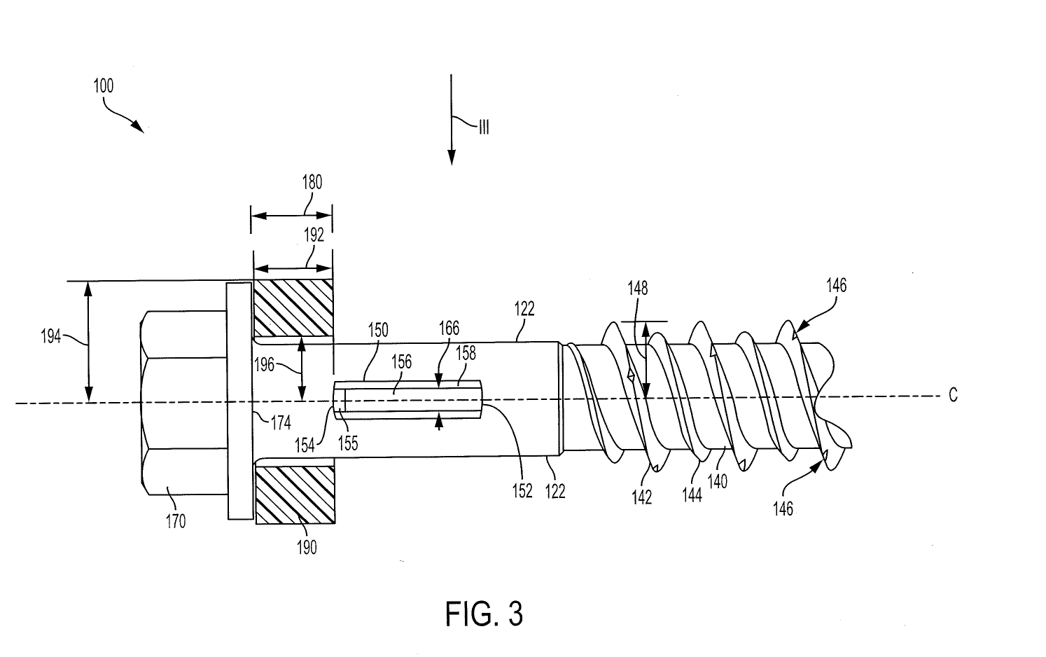

In one example, the unthreaded section 122 includes a structural feature extending in a radial direction from the unthreaded section 122. The structural feature has an upper extent which is on a plane parallel to the leading surface 174. The structural feature and the upper extent, in one example, define a ledge, or other holding element, to maintain a washer 190 (discussed below) substantially parallel with the leading surface 174. In the example fastener 100 shown in FIG. 1, the structural feature may include at least one wing 150 (or as shown, two wings 150) radially protruding from the unthreaded section 122. The wings 150 begin at a lower transition 152, the intersection of the wings 150 and the shank 120, and extend to an upper extent or upper edge 154 in a direction towards the head 170. In one configuration, between the lower transition 152 and the upper edge is an outer edge 156 and a transition edge 155 between the outer edge 156 and the upper edge 154. The outer edge 156 and the unthreaded section 122 form an angle 164 between them. Angle 164 may vary depending on the material of the work piece. For example angle 164 can be varied to be less for use in metal than for use in woods or concrete. Lower transition 152, in one example, is the first portion of the wing(s) 150 that interacts with the work piece. Thus, lower transition 152, along with angle 164, thickness 166 (FIG. 3), length 160, sharpness/taper, and placement of the wings(s) along the shank 120 may all be adjusted based on the properties of various applicant materials, for example, wood, concrete, metal, composites, or any other material. For example, in one application, a fastener 100 for use in concrete may have a wing 150 which has a shorter length 160, a larger thickness 166, a larger angle 164, and decreased sharpness/taper as compared to a fastener 100 for use in metals.

The fastener 100 embodiment shown in FIG. 1 is shown as a continuous wing 150 from transition 152 through upper edge 154. This example structural feature, i.e. wing 150, can serve multiple functions, that is, for example, providing the leveling/holding benefits to the washer 190 while also providing cutting and cleaning benefits, which will be described further below. However, this disclosure is not limited to those example fasteners in which the structural feature is a single element. For example, certain embodiments may include a structural feature for the holding element and a different structural feature for the cutting element. One example includes a gap between the cutting element and the holding element. The holding element, in one non-limiting example, can include a structural feature around, or partially surrounding, the circumference of the shank 120, for example a lip or raised edge, closer to the head than the cutting element. The cutting element, in one non-limiting example, may include one or more cutting elements either separate from or integrated with the holding element. With further reference to FIG. 1, the structural feature, wing 150 includes both the holding element, upper extent or upper edge 154, and cutting element, outer edge 156.

The outer most portion of the wing 150 would form a circle having a radius 162 if rotated completely around the center line C of the fastener 100. Thus, the dimension 162 will be referred to as the radius 162 of the wing 150. The wing 150 has a length 160, parallel to the centerline axis C, from the intersection of the upper edge 154 with the unthreaded section 122 to the lower transition 152. The length 160 and radius 162 may be varied in accordance with the material of the work piece and the desired cutting properties. A longer length 160, for example, may be used for metal materials. A larger radius 162 would be used for larger thread outer diameters. In one example, the radius 162 is greater than or equal to the largest thread outer radius 148. In one example, the radius 162 is greater than the largest thread outer radius 148. Having the radius be larger than the largest thread outer radius 148 can improve the sealing of the washer 190 by cutting and cleaning the threads previously cut into the work piece by the threaded section 140. Outer edge 156 may be, in one example, a flat edge, i.e., it is substantially concentric with the unthreaded section at its largest radius. In another example, outer edge 156 is sharpened, or angled with respect to the unthreaded section thereby creating a more sharpened cutting edge for reaming or boring cut threads and or surfaces in the respective work piece. That is, the thickness 166 (FIG. 2) may be tapered to a point. The sharpness of the outer edge 156, or degree of taper, can vary depending on the type of application and material. In one example, having a shaper edge can be more advantageous for use on metals or woods and other examples, having a less sharp edge can be advantageous for concrete.

In one example, sealant or washer 190 is between the upper edge 154 and the underside or leading surface 174 of the head. The upper edge 154, in one example, is parallel, or substantially parallel with the leading surface 174 such that when the washer 190 rests on the upper edge 154 of the wing(s), the washer is maintained substantially parallel with the leading surface 174. The upper edge 154 is a distance 180 from the leading surface 174. In one example, the washer 190 has a thickness 192 that is equal to or substantially equal to the distance 180 when not under compression. In one example, as shown, the thickness 192 may be slightly less than the distance 180 to allow for installation of the washer 190 without binding. The design thickness 190 of the washer also impacts the location of the wing(s) 150 along the shank 120. That is, a fastener for use with a thicker washer will result in the placement of the wings 150 lower on the shank 120 than on a fastener for use with a thinner washer. Washer 190 has an inner radius 196 and an outer radius 194. In one example, inner radius 196 is greater than or equal radius 148. Having radius 196 be greater than or equal to radius 148 can aid installing the washer 190 onto the fastener 100 without rolling the washer 190 and allows the washer to move independent of the fastener 100. Further, the radius 196, in one example, can be a size that corresponds to the diameter of the shank 120. That is a larger shank and radius 148, the larger the radius 196. Outer radius 194 may be any size. In one particular example, outer radius 194 is sized to be substantially equally to an outer radius of head 170.

FIG. 2 shows the same view of fastener 100 as FIG. 1 and also shows one example of the remaining portion of threaded section 140. Fastener 100 has a point 110. The point 110, for example, may be a diamond point, which, in one example, may be used for concrete or other masonry application. However, other points may be included based on the application and material.

FIG. 3 shows a side view of example fastener 100 rotated 90 degrees. Wings 150 have outer edge 156 and thickness 166. The thickness 166 may be adjusted for the type of application and materials. For example, a larger thickness 166 may be used for applications requiring more torque, while a smaller thickness 166 may be used for application requiring less torque. As noted above, outer edge 156 may be angled so as to provide a tapered thickness 166, thus providing a sharpened cutting edge.

Fastener 100, in one example, may be formed in several steps. For example, the head 170 may be formed by cold heading techniques using either single or double blow heading. In other examples the head 170 may be hot formed, milled, or formed using other known techniques in accordance with desired head configurations. In one example, wing(s) 150 may be formed by pinching the unthreaded section 122 with a pinch pointer. The wing(s) 150 may be formed either before or after formation of threaded section 140, which may be formed by any, known thread forming technique, which in one example may be thread rolling.

The washer 190, in one example, is manufactured separate from remaining portions of fastener 100 and then moved over the tip 110, the threaded section 140, and the wings 150 to the region between the wings 150 and the head 170. The washer 190, in one example, is added to the fastener 100 after forming the threaded section 140 and the wings 150. The washer may be placed between the wings 150 and the head 170 with or without relative rotational motion between the fastener 100 and the washer 190. In one example, the washer is installed passing over the threaded section 140. In one example, adding the washer 190 occurs following any heat treatment, plating, coating, or other treatment to be completed.

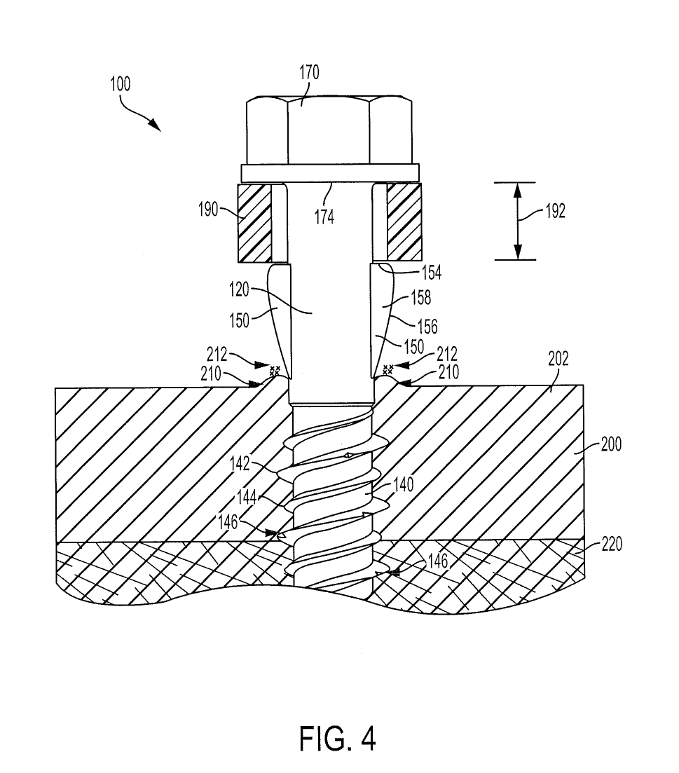

FIGS. 4-7 show several stages of insertion of fastener 100 in use during a method of securing a work piece 200 to a substrate 220. The figures are shown having metal work piece 200 and a wood substrate 220, as an example. However, either the work piece 200 or the substrate 220 may be any of the materials or like materials discussed in the example applications, above, or throughout the application as well as those understood by a person of ordinary skill in view of the present application. As shown in FIG. 4, fastener 100 is in the process of being inserted into the work piece 200 and the substrate 220. As a result of the threaded section 140 cutting into the work piece, and depending on the material of the work piece 200, bulging 210 and/or debris 212 may form at the surface that could interfere with washer 190 if the washer 190 was seated without cleaning and/or leveling. Further, the dimensions of the fastener 100 and wings 150 provide the washer 190 with a stable support structure including upper edge 154 and leading surface 174 and prevent the washer 190 from rolling/sliding down the shank 120, whether it be the unthreaded section 120 or threaded section 140. The structural feature, i.e., wings 150 in this example, function to maintain the broad surface of washer 190 parallel, or substantially parallel, to the leading surface 174, which will result in a more effective seal over the prior art.

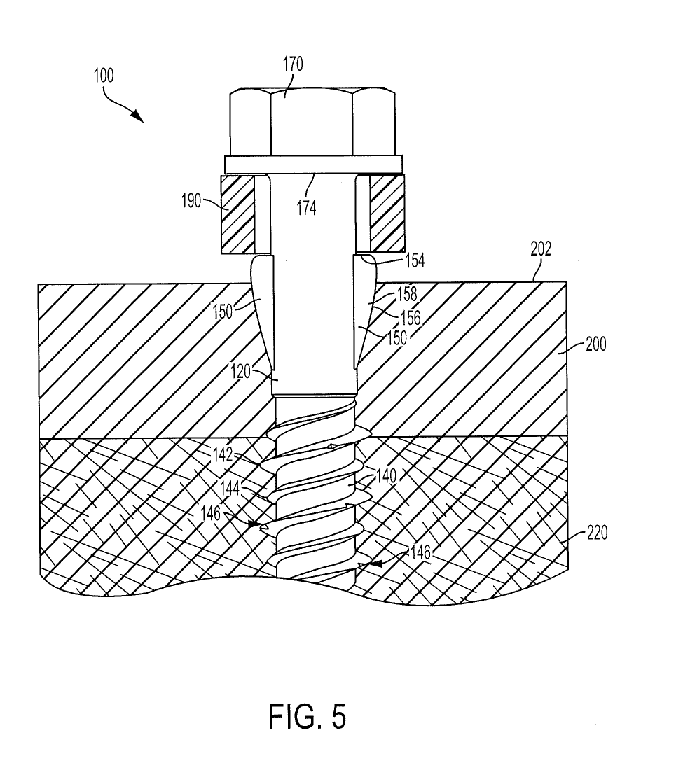

With reference to FIG. 5, as the fastener 100 is continued to be inserted into the work piece 200 by rotation. The wings 150, in this example two wings 150, make contact with the upper surface 202 of the work piece 200. As the fastener 100 is rotated, the wings bore or cut away and clean, with each rotation, a portion of the work piece 200. For example, the portion bored or cut away and cleaned may include threads cut in the work piece by threaded section 140, bulging work piece material 210, and/or debris 212 (FIG. 4), thus creating a clean and level surface. In the example fastener 100 shown in FIG. 5, the wings 150 provide a level and clean fastening surface in a single step process, i.e., the rotation/insertion of wings 150. In one example, and as shown in FIG. 5, the radius of the wings 150 increases in a direction toward the head, and thus the area of the work piece upper surface 202 cut by the wings 150 increase as the fastener 100 is inserted further into the work piece 200.

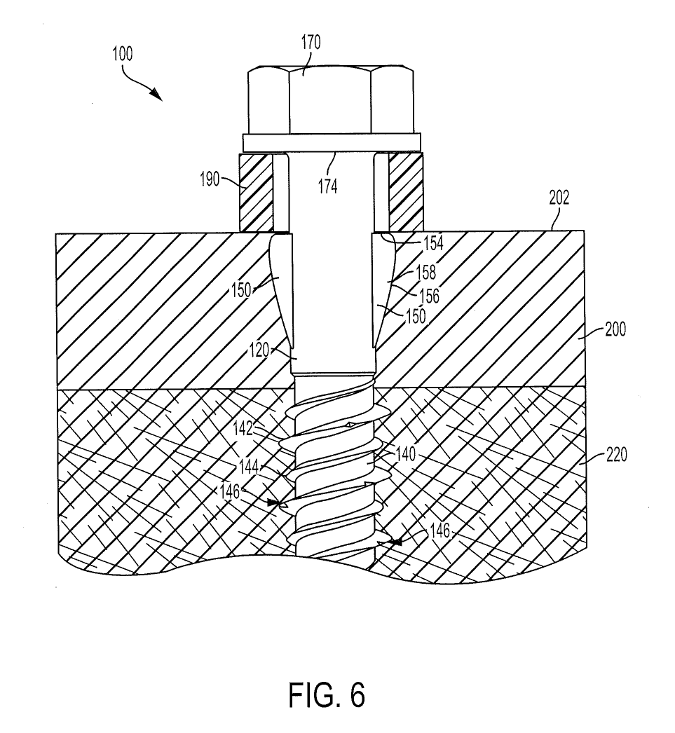

FIG. 6 shows continued insertion of the fastener 100 into the work piece 200. As shown, the wings 150 just passed through the upper surface 202 of work piece 200. Thus, the upper surface 202 has been cleaned and leveled. The washer 190 makes contact with the upper surface 202 and the lower broad surface of washer 190 forms an improved seal with the work piece 200. In one example, and depending on the washer design and material, the fastener is not inserted further into the work piece, thus FIG. 6 shows an example secured position. The fastener 100 is dimensioned such that in the secured position the upper edge 154 of wings 150 is not in contact with substrate 220, i.e., the wings 150 do not fully pass through work piece 200. In one example, and based on the particular materials and dimensions in use, having the wings not fully pass through the work piece 200 may increase the strength of the work piece 200 and/or the holding strength of fastener 100 as compared to a work piece with other structural features passing all the way through the work piece 200.

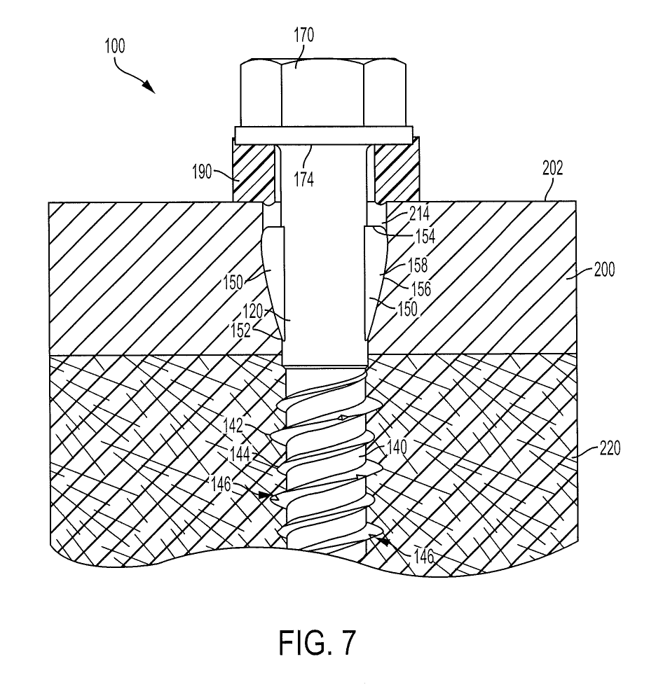

With reference to FIG. 7, if desired or according to washer 190 design, the fastener 100 may be inserted further to apply additional compressing force on the washer 190 between the head 170 and the work piece 200 as shown. Thus, FIG. 7 shows another example secured position. Once the upper edge 154 passes beneath an upper surface 202 of the work piece 220, the washer 190 continues to contact the upper surface 202 and the washer 190 is compressed between leading surface 174 of head 170 and upper surface 202 with continuous insertion of the fastener 100. Bore hole 214 remains between wings 150 and washer 190. Depending on the material, resiliency, and dimension of the washer 190, the washer 190 may be compressed at least partially into bore hole 214, and or above leading surface 174, both of which may contribute to the effectiveness of the formed seal.

In one example, the fastener 100 is dimensioned such that in the secured position the upper edge 154 of wings 150 is not in contact with substrate 220, i.e., the wings 150 do not fully pass through work piece 200. Consequently, the bore hole 214 also does not fully pass through work piece 200. In one example, and based on the particular materials and dimensions in use, having the bore hole not fully pass through the work piece 200 may increase the strength of the work piece 200 and/or the holding strength of fastener 100 as compared to a work piece with bore 214 passing all the way through the work piece 200.

In another example, all portions of the wings 150 are in contact with the work piece 200 in the secured position, i.e., no portion of the wings 150 are in contact with the substrate 220. As shown, in one example, transition 152 remains in contact with work piece 200 in the secured position.

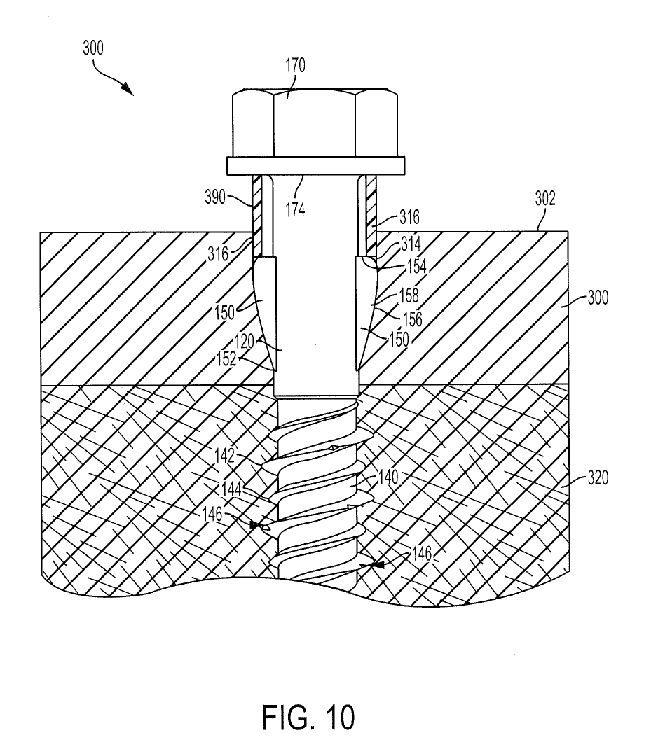

FIG. 8 shows another example fastener 300. Fastener 300 is similar to fastener 100 of FIG. 1 and like reference numerals will reference like features. Fastener 300 differs from fastener 100 in that fastener 300 includes sealant 390 having outer radius 394 and inner radius 396. Sealant 390 is sized relative to the wings 150 radius 162 such that upon insertion of the fastener into a work piece, sealant 390 enters the bore hole 314 (FIG. 10) to form a seal, which will be discussed further below. Outer radius 394, in one example, is greater than or equal to wing radius 162 such that the sealant 390 is forced into bore hole 314 (FIG. 10) upon insertion of fastener 300. Sealant outer radius 394 may be larger than wing radius 162 so long as the leading edge of the sealant does not prevent the further insertion of the sealant 390 into the bore hole 314 (FIG. 10) formed by the wings 150. In some examples, having radius 396 be slightly larger than radius 162 will ensure the sealant 390 can enter the bore hole, yet still forms a tight seal.

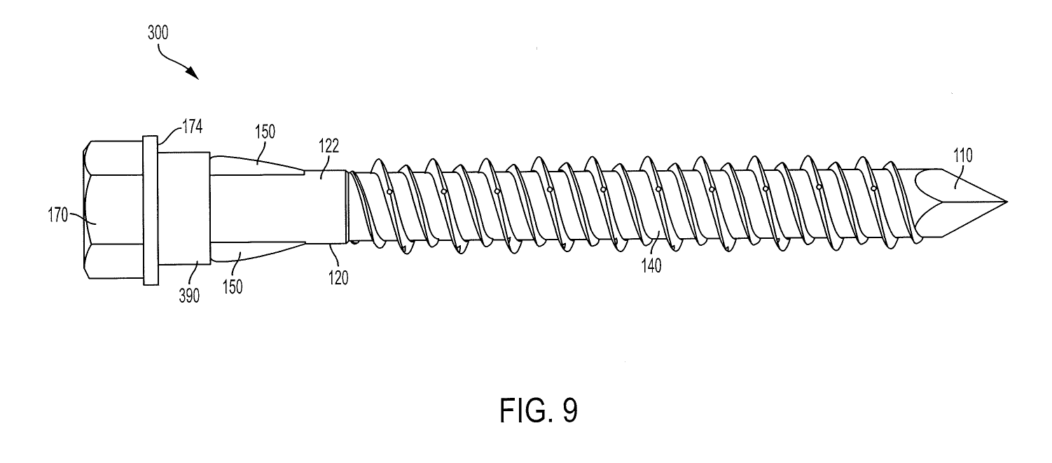

FIG. 9 shows another view of example fastener 300 like that in FIG. 8. However, in FIG. 9, the sealant 390 is not shown in cross-section.

FIG. 10 shows insertion of the fastener 300 into the work piece 300. As shown, the wings 150 just passed through the upper surface 302 of work piece 300. Thus, the upper surface 302 has been cleaned and leveled. The sealant 390 follows the wings 150 into bore hole 314 to form an improved seal at sealing interface 316 with the work piece 300. The figures are shown having metal work piece 300 and a wood substrate 320, as an example. However, either the work piece 300 or the substrate 320 may be any of the materials or like materials discussed in the example applications, above, or throughout the application as well as those understood by a person of ordinary skill in view of the present application.

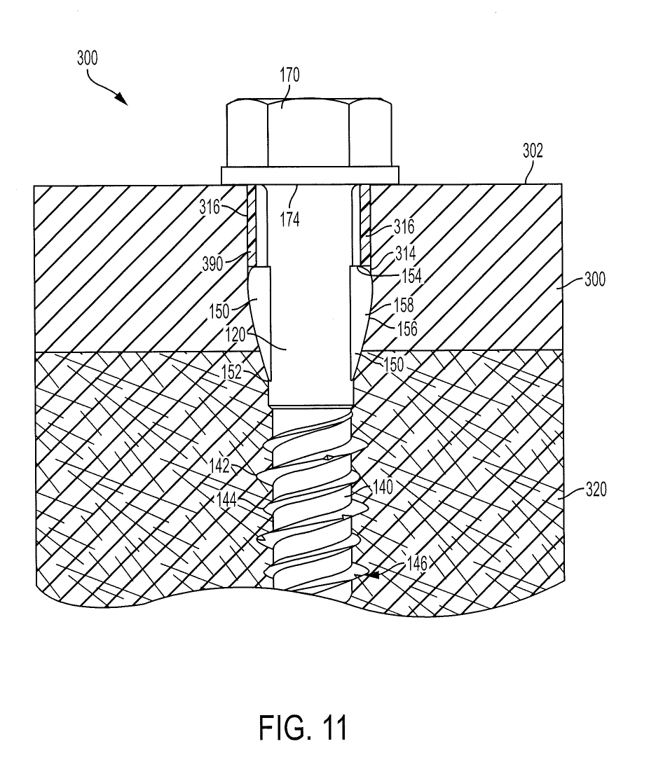

FIG. 11 shows fastener 300 in a fully secured and sealed position. Sealant 390 nests inside bore hole 314 formed by wings 150 and creates a sealing interface 316 between sealant 390 and work piece 300. Leading surface 174 of head 170 further compresses against sealant 390 establishing a seal between leading surface 174 and sealant 390. Fastener 300 with sealant 390 has sealing advantages where a more flush appearance is desired while still maintaining an improved seal to prevent intrusion of the environment into the bore hole 314. The fastener 300 is dimensioned such that in the secured position the upper edge 154 of wings 150 is not in contact with substrate 320, i.e., the wings 150 do not fully pass through work piece 200. In one example, and based on the particular materials and dimensions in use, having the wings not fully pass through the work piece 300 may increase the strength of the work piece 300 and/or the holding strength of fastener 300 as compared to a work piece with other structural features passing all the way through the work piece 300. In another example, fastener 300 can be dimensioned such that wings 150 pass through work piece 300 and into substrate 320 such that bore hole 314 continues into substrate 320. In such an example, sealant 390 passes through work piece 300 and makes at least partial contact with and/or enters bore hole 314 formed in substrate 320 to provide sealing of the bore hole 314 in the substrate.

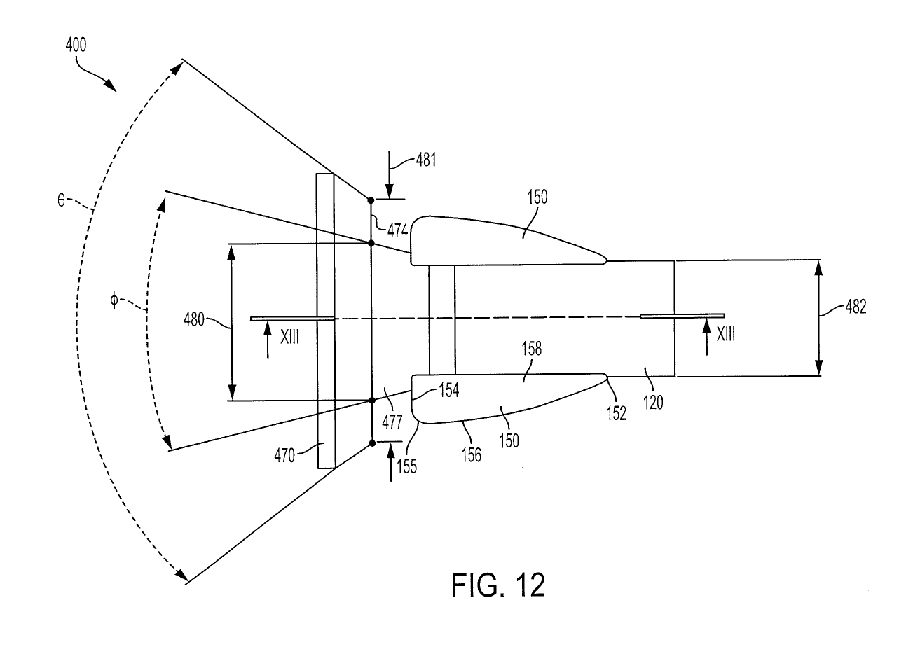

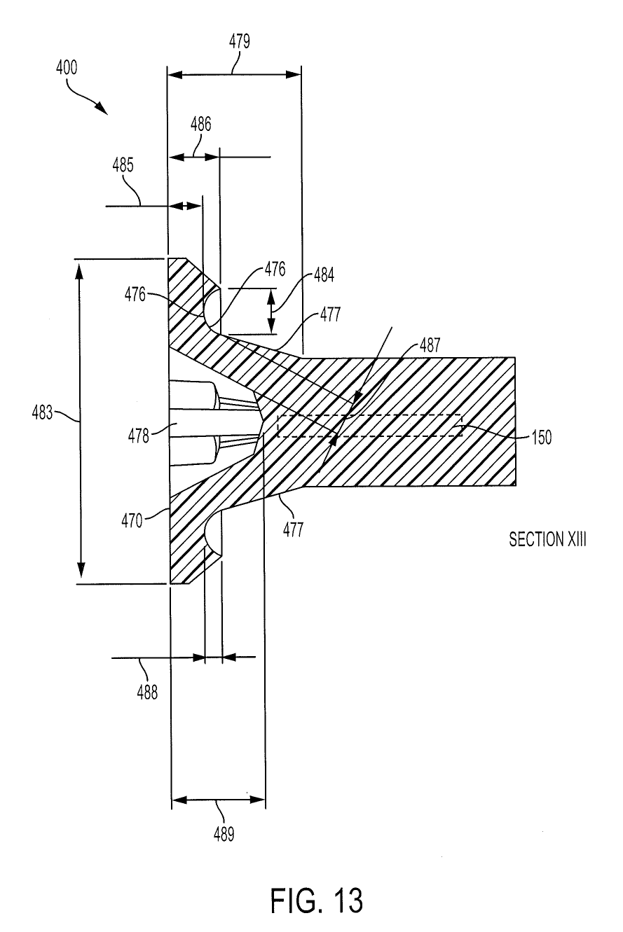

FIGS. 12-13 show fastener 400 in another example embodiment and like reference numerals will reference like features. Fastener 400 is similar to fastener 100 and 300. However, fastener 400 includes a flat head 470 having a tapered neck 477, which transitions from the head 470 to the shank 120. With reference to FIG. 13, head 470 includes a grove 476 for retaining a similarly shaped washer, which will be discussed further below. The groove 476 may have any size and shape matching the respective washer. For example, the grove 476 shown is semi-circular. Other example grooves may include a rectangular groove, a triangular groove, alternating peaks and valley grooves, or the like. Head 470 also include a driver engageable recess 478 configured to receive a driver.

Non-limiting example dimensions in millimeters are shown for one particular fastener head. Although, the dimensions of wings 450 are not drawn to scale. It should be noted that dimensions displayed are a single example. For example, as shown the flat head 470 is tapered from a diameter 483 (FIG. 13) of about 12.20 mm to a diameter 481 of about 10.00 mm at a taper angle θ of about 80°. The tapered neck 477 is tapered from a diameter 480 of about 6.50 mm at an angle Φ of about 30° to a depth 479 from a top surface of the head 470 of about 5.10 mm. And the shank has a diameter 482 of about 4.82 mm.

As shown in FIG. 13 the groove 476 has a width 484 of about 1.76 mm and a height 485 of about 1.37 mm. The bottom of the groove 476 is shown, for example, to have a depth 486 of about 2.00 mm from a top surface of the head 470. And the groove 476 has a height 488 of about 0.63 mm. The wall thickness 487 between the groove 476 and the recess 478 is, for example, about 1.29 mm. The recess is shown, for example having a depth 489 of about 3.58 mm.

Absolute and relative dimensions may be varied for a particular application in order to meet applicable torque and material holding requirements.

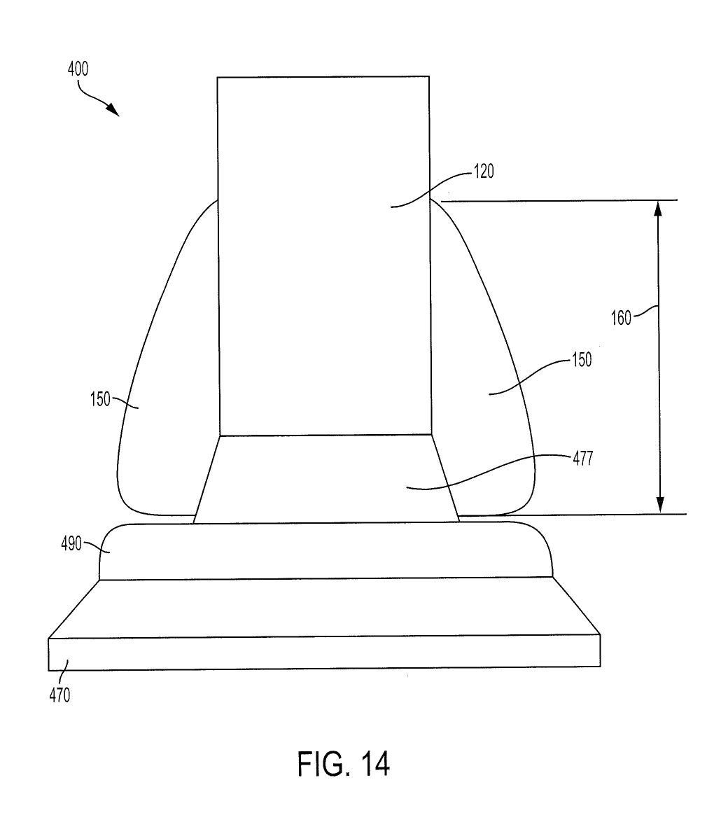

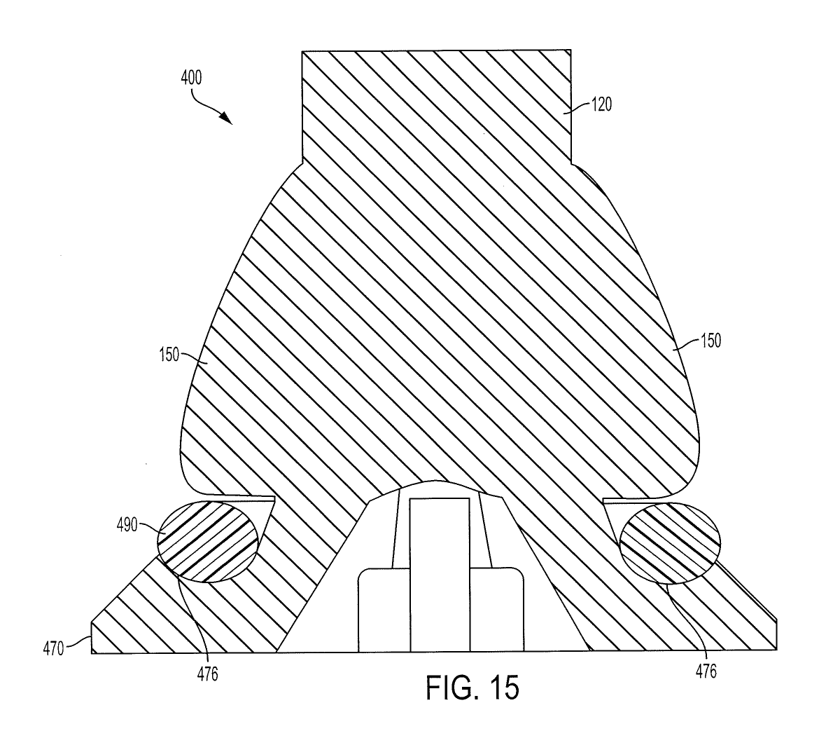

A side view of fastener 400 is shown in FIG. 14 with washer 490. Washer 490, as well as any of washer 190, sealant 390, and sealant 690 may, in one example be an o-ring, or any other sealant material made of, for example, rubber, cork, silicone, or plastic. It is shown throughout the figures as a resilient rubber material. However, it may also be any of the materials or like materials discussed throughout the specification as well as those understood by a person of ordinary skill in view of the present application. With reference to FIG. 15, which shows a cross section of FIG. 14, washer 490 is retained between wing 150 and head 470 and conforms in shape to grove 476. As shown, washer 490 has a circular cross section. However, other cross sectional shapes may also be used. Although shank 120 and wings 150 are shown with different crosshatches, they are the same material.

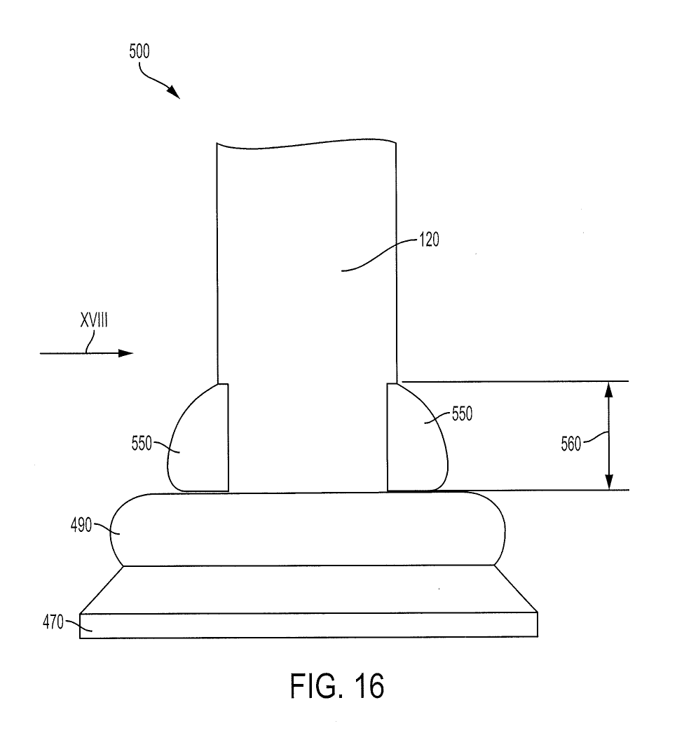

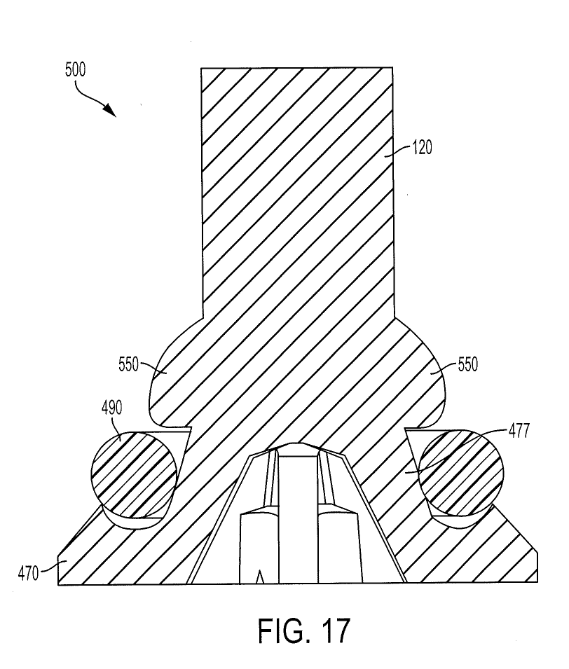

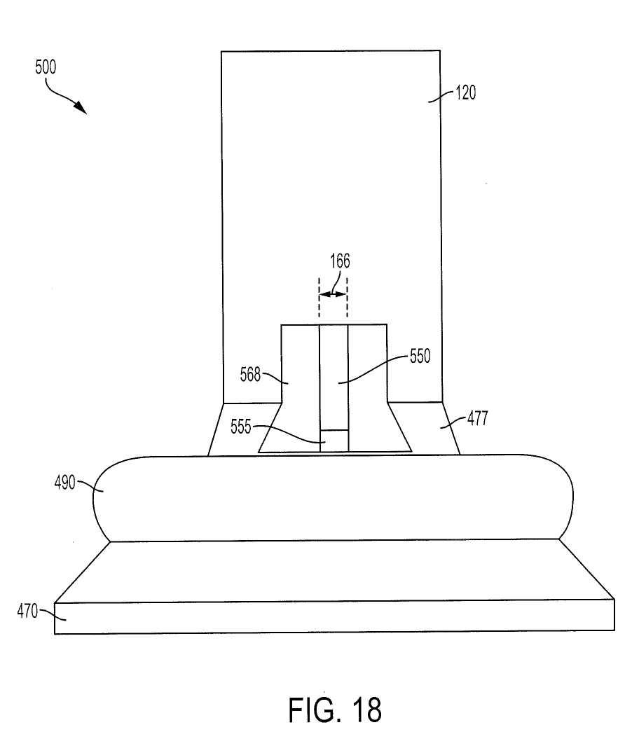

Example fastener 500 of FIGS. 16-18 are similar to fastener 400 of FIGS. 14 and 15. However, the wings 550 of fastener 500 have a shorter length 560 than length 160 (FIG. 14) of fastener 400. This shows one additional example of the variation in shape and configurations of disclosed wing features. FIG. 18 is a view of fastener 500 like that of FIG. 16 rotated 90 degrees in the view of arrow XVIII of FIG. 16. In this view, base 568 is shown. Base 568 is the portion of shank 120 that has been pinched, or otherwise machined or tooled, to form wings 550. The shape of base 568 can vary depending on the size and shape of wings 550.

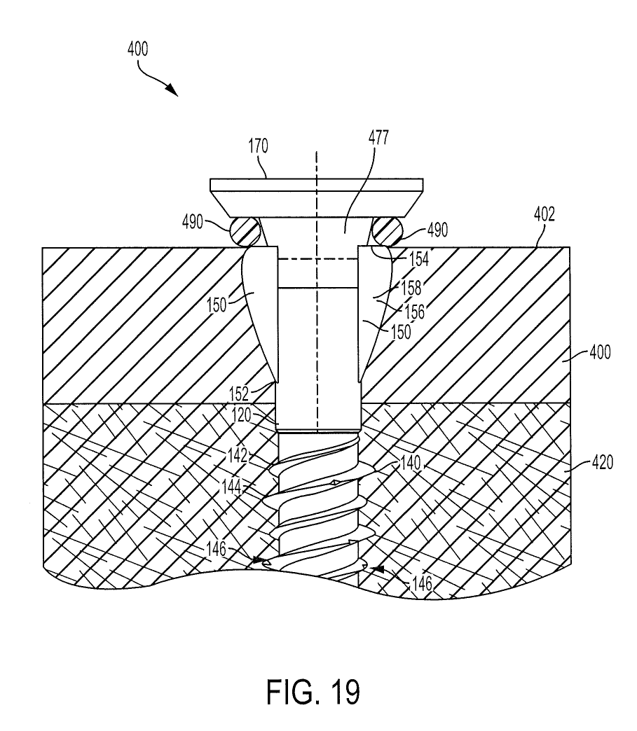

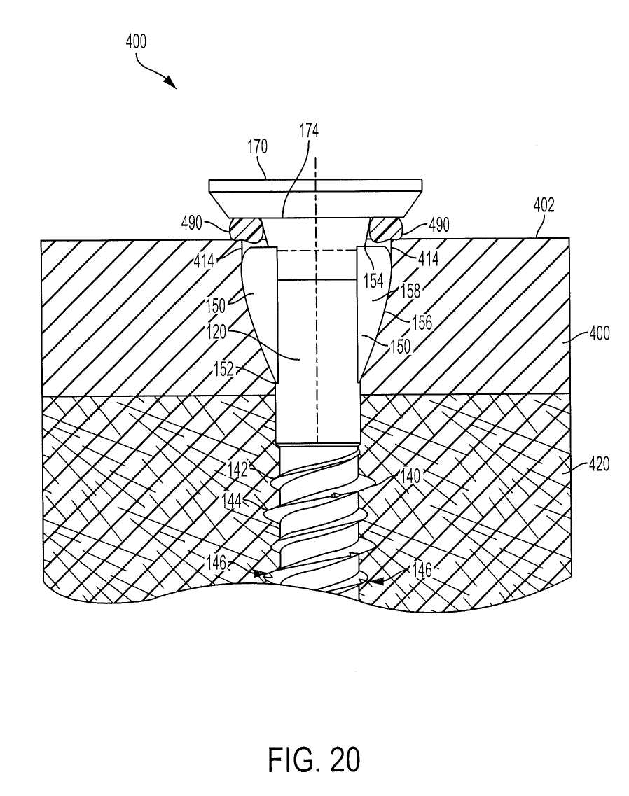

FIGS. 19 and 20 show fastener 400 in use during a method of securing a work piece 400 to a substrate 420. The figures are shown having metal work piece 400 and a wood substrate 420, as an example. However, either the work piece 400 or the substrate 420 may be any of the materials or like materials discussed in the example applications, above, or throughout the application as well as those understood by a person of ordinary skill in view of the present application. As shown in FIG. 18, fastener 400 has already been inserted into work piece 400 and the substrate 420. Similar to the fastener 100 of FIGS. 4-5, as the fastener 400 is continued to be inserted into the work piece 400 by rotation, the wings 150 bore or cut away and clean, with each rotation, a portion of the work piece 400. For example, the portion bored or cut away and cleaned may include threads cut in the work piece by threaded section 140, bulging work piece material 210, and/or debris 212 (FIG. 4), thus creating a clean and level surface. In the example fastener 400 shown in FIG. 18, the wings 150 provide a level and clean fastening surface in a single step process, i.e., the rotation/insertion of wings 150.

FIG. 20 shows continued insertion of the fastener 400 into the work piece 400. As shown, the wings 150 just passed through the upper surface 402 of work piece 400. Thus, the upper surface 402 has been cleaned and leveled. The washer 490 makes contact with the upper surface 202 and the washer 490 forms an improved seal with the work piece 200. In one example, and depending on the washer design and material, the fastener is not inserted further into the work piece, thus FIG. 20 shows an example secured position. The fastener 400 is dimensioned such that in the secured position the upper edge 154 of wings 150 is not in contact with substrate 420, i.e., the wings 150 do not fully pass through work piece 400. In one example, and based on the particular materials and dimensions in use, having the wings not fully pass through the work piece 400 may increase the strength of the work piece 400 and/or the holding strength of fastener 400 as compared to a work piece with other structural features passing all the way through the work piece 400. If desired, or according to fastener design, the fastener 400 may be inserted further. In one example, washer 490 may be compressed until it is guided into the bore hole 414 as a sealant. With additional insertion, the leading surface 174 of head 170 can rest evenly with upper surface 402 in a secured position or, in another example, be countersunk into work piece 400 in a secured position.

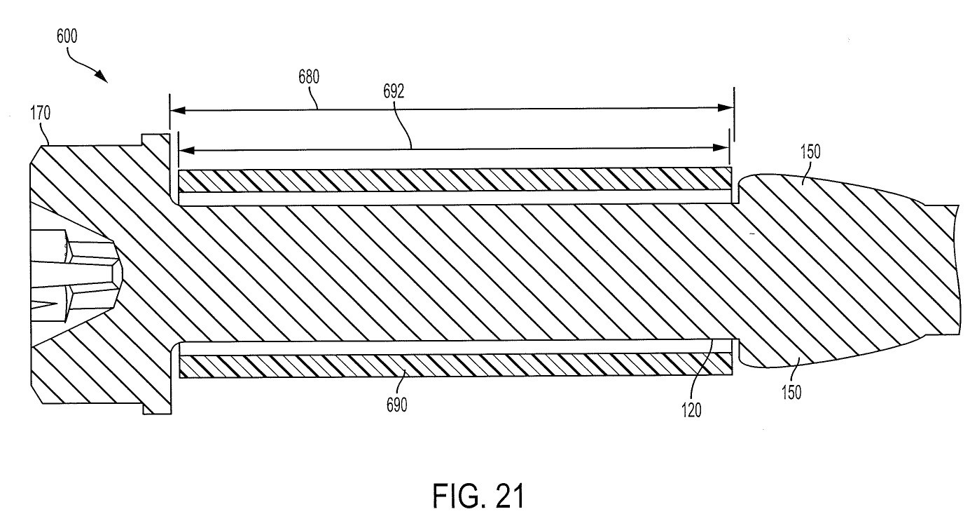

FIG. 21 shows another example fastener 600. Fastener 600 is similar to fastener 300 of FIGS. 8-11 and like reference numerals will reference like features. Fastener 600 differs from fastener 300 in that fastener 600 and sealant 690 are dimensioned for a thicker work piece. That is, distance 680 and thickness 692 are larger with respect to the remaining dimensions of fastener 600. Such relative dimensions can be used, for example, in thicker work pieces or, in applications where it is desired for the wings 150 to fully penetrate the work piece during insertion.

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure.

What is claimed as new and desired to be protected by Letters Patent of the United States is:

1. A threaded fastener for fastening a work piece to a substrate, the threaded fastener comprising:
a head having a top surface and a leading surface;
a shank having a threaded section and an unthreaded section;
at least one wing extending from the unthreaded section in a radially outward direction from a longitudinal axis of the shank, the at least one wing for cutting the work piece, wherein the at least one wing has an upper extent on a plane parallel to the leading surface of the head;
at least one washer disposed between the at least one wing and the head, wherein the washer has a thickness substantially equal to a distance between the upper extent of the at least one wing and the leading surface of the head.

2. The threaded fastener of claim 1, wherein the at least one wing is configured to maintain the washer substantially parallel with the leading surface of the head during insertion.

3. The threaded fastener of claim 1, wherein the distance between the upper extent of the at least one wing and the leading surface of the head is greater than zero.

4. The threaded fastener of claim 1, wherein the distance between the upper extent of the at least one wing and the leading surface of the head is dimensioned such that the at least one wing does not fully pass through the entirety of a thickness of the work piece when the threaded fastener is in a secured configuration.

5. The threaded fastener of claim 1, wherein the at least one wing increases in radius in a direction toward the head.

6. The threaded fastener of claim 1, wherein the at least one wing radiates outward from the unthreaded section of the shank.

7. The threaded fastener of claim 1, wherein the at least one wing has an outer radius greater than an outer radius of a thread.

8. The threaded fastener of claim 1, wherein the at least one wing has an outer radius greater than a greatest outer radius of the threaded section.

9. The threaded fastener of claim 1, wherein the washer includes an inner radius and the washer inner radius is greater than a greatest outer radius of the threaded section.

10. The threaded fastener of claim 1, wherein the washer includes an inner radius and the washer inner radius is less than an outer radius of the at least one wing.

11. The threaded fastener of claim 1, wherein the washer has a thickness which is greater than or equal to one half the distance between the upper edge of the at least one wing and the leading surface of the head.

12. The threaded fastener of claim 1, wherein the washer has a thickness that is equal to a distance between the upper extent of the at least one wing and the leading surface of the head.

13. A method of forming a threaded fastener for fastening a work piece to a substrate, the method comprising:
obtaining a shank having an unthreaded section;
forming a head having a top surface and a leading surface;
rolling the shank to form a threaded section comprising threads;
pinching the unthreaded section to form at least one wing extending from the unthreaded section in a radially outward direction from a longitudinal axis of the shank, the at least one wing for cutting the work piece, wherein the at least one wing has an upper extent on a plane parallel to the leading surface of the head;
heat treating and/or plating the fastener; and
placing over the threaded section at least one washer between the wings and the head, wherein the washer has a thickness substantially equal to a distance between the upper extent of the at least one wing and the leading surface of the head.

14. A method of securing a work piece to a substrate, the method comprising:
providing a threaded fastener having:
a head having a top surface and a leading surface;
a shank having a threaded section and an unthreaded section;
at least one wing extending from the unthreaded section in a radially outward direction from a longitudinal axis of the shank, the at least one wing for cutting the work piece, wherein the at least one wing has an upper extent on a plane parallel to the leading surface of the head; and,
at least one washer disposed between the wings and the head, wherein the washer has a thickness substantially equal to a distance between the upper extent of the at least one wing and the leading surface of the head; and,
screwing the fastener into the work piece;
reaming at least a portion of a thread cut in the work piece by the threaded section; and
seating the washer between the leading surface and the work piece for sealing a hole formed by the fastener in the work piece.
